(19) United States
(12) Patent Application Publication
(10) Pub. No.: US 2013/0332041 A1
(43) Pub. Date: Dec. 12, 2013

(54) BRAKE PRESSURE COMPENSATION SYSTEM AND METHOD THEREOF

(71) Applicants: HYUNDAI MOTOR COMPANY, Seoul (KR); KIA MOTORS CORPORATION, Seoul (KR); MANDO CORPORATION, Pyeongtaek-si (KR)

(72) Inventors: Taeg Jo KIM, Seoul (KR); Seong-Yon RYU, Seoul (KR)

(73) Assignees: Hyundai Motor Company, Seoul (KR); Mando Corporation, Pyeongtaek-si (KR); Kia Motors Corporation, Seoul (KR)

(21) Appl. No.: 13/714,905

(22) Filed: Dec. 14, 2012

(30) Foreign Application Priority Data
Jun. 12, 2012 (KR) 10-2012-0062700

(51) Int. Cl. B60T 8/44

(52) U.S. Cl. CPC B60T 8/441
USPC 701/70

(57) ABSTRACT

A brake pressure compensation method may include determining a vehicle speed, the magnitude of a negative pressure, and the pressure of a master cylinder, determining brake intention from a change in pressure of the master cylinder, and deciding a brake pressure from the amount of pressure of the master cylinder, determining the compensation amount of the brake pressure by applying the magnitude of a negative pressure of a booster, and performing brake control by compensating for a hydraulic brake pressure through an ESC module.

### CROSS-REFERENCE TO RELATED APPLICATION

The present application claims priority to Korean Patent Application No. 10-2012-0062700 filed on Jun. 12, 2012, the entire contents of which is incorporated herein for all purposes by this reference.

### BACKGROUND OF THE INVENTION

1. Field of the Invention

The present invention relates to a hydraulic brake pressure compensation system. More particularly, the present invention relates to a hydraulic brake pressure compensation system that determines braking intention and brake pressure and allows providing stable braking force by compensating for hydraulic brake pressure with an ECU module, without a brake pedal effort sensor, and a method thereof.

2. Description of Related Art

Vehicles are equipped with a brake system that decelerates or stops the vehicles, if necessary, when the vehicles travel.

The brake system generates a braking force by converting the kinetic energy of a vehicle into heat energy, using friction force, and by dissipating the heat energy to the atmosphere in a traveling state.

In the brake system, when a request for braking is generated by a brake pedal, the hydraulic pressure or pneumatic pressure generated by a booster by a negative pressure of the engine operates brake cylinders mounted on the calipers of the front wheels and the rear wheels to strongly hold both sides of discs with brake pads, thereby generating a braking force.

The negative pressure of an engine is generated in the intake stroke and the performance of the negative pressure depends on various factors such as mechanical friction load of the engine, efficiency of the transmission (particularly, an automatic transmission), load on auxiliary components or electric devices, and the shape of the intake system.

Therefore, as electric load is increased by using an air-conditioning system in traveling in summer, load of an alternator is increased by a charging/discharging logic and the negative pressure of the engine rapidly decreases, such that a required negative pressure is difficult to maintain and stable braking performance cannot be provided.

Since the negative pressure of an engine is influenced by the ignition timing, a method of improving the negative pressure of an engine by advancing the ignition timing has been used, but when the ignition timing is excessively advanced, many restrictions are caused, for example, in exhaust gas regulation, power performance, fuel efficiency, and NVH (Noise/Vibration/Harshness).

As another example, a method of improving the negative pressure of a booster by additionally mounting an intensifier has been used, but when it is applied to a vehicle with 1.5 L or less, excessive air passing through an IBS (Intensifier Brake System) flows into the engine and may cause malfunction of the engine.

As another method, a technology that ensures stable braking performance by compensating the negative pressure of an engine, by connecting a mechanical vacuum pump to a camshaft or additionally disposing an electric vacuum pump is provided.

However, as an expensive vacuum pump is added, the manufacturing cost increases and price competitiveness is deteriorated, and designing of a layout and the assembly process are complicated, such that productivity is deteriorated, and the weight increases and the load for driving the vacuum pump is allotted, such that the fuel efficiency decreases and the engine output torque reduces.

As another example, Japanese Patent Laid-Open Publication No. 2009-085145 discloses a technology of keeping negative pressure of a booster stable by controlling the open area of an intake valve to increase in accordance with whether the negative pressure of the booster satisfies a target negative pressure, by additionally disposing a negative pressure sensor in a brake booster

However, designing of the engine and the assembly process are complicated, such that productivity is deteriorated and the manufacturing cost is increased, which decreases price competitiveness.

Further, there is a problem in the vehicles of the related art that it is necessary to use a brake pedal sensor that detects effort of a brake pedal in order to determine On/Off of the brake pedal by a driver.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hydraulic brake pressure compensation system and a method thereof having advantages of providing a stable braking force by determining braking intention and a brake pressure from the pressure of a master cylinder without a brake pedal effort sensor, by determining the magnitude of a negative pressure from a booster pressure, by determining the amount of compensation of necessary hydraulic pressure, and compensating for the hydraulic pressure with an ESC module.

In an aspect of the present invention, a brake pressure compensation system may include a sensor unit that detects a pressure of a master cylinder according to operation of a brake pedal, a vehicle speed, a booster pressure according to an intake negative pressure of an engine, and status of the engine, a control unit that determines brake intention and a brake pressure from the pressure of the master cylinder, determines compensation amount of the brake pressure in accordance with magnitude of negative pressure of the booster, and compensates for a hydraulic brake pressure through an (Electronic Stability Control) ESC, and a driving unit that controls a motor and a valve of an ESC module to compensate for the hydraulic brake pressure in response to a control signal from the control unit.

The sensor unit may include a vehicle speed detector that may include wheel speed sensor mounted on wheels to detect wheel speed of wheels, a master cylinder pressure detector that detects a change in pressure according to the operation of the brake pedal, a booster pressure detector that detects the negative pressure of the booster which is generated by the intake negative pressure of the engine, and an engine status detector that detects information including a displacement of an acceleration pedal, status of an intake system, altitude of area where a vehicle travels, and a driving environment.

The control unit determines the brake intention from a change in the pressure of the master cylinder and determines the brake pressure from amount of the pressure of the master cylinder.

The control unit controls the brake pressure in accordance with deceleration/acceleration speeds of wheels, operational conditions of the engine and environment conditions.

The control unit determines the brake pressure from the pressure of the master cylinder according to a brake effort, performs one-to-one conversion on the pressure of the master cylinder on the basis of the magnitude of a normal negative pressure, and then determines the compensation amount of the braking force in accordance with the magnitude of the negative pressure.

The control unit may include a speed/deceleration estimator that estimates speed and deceleration/acceleration speed by analyzing wheel speeds of wheels into a rate of change in speed per unit time, a brake intention determiner that determines the brake intention from a change in pressure of the master cylinder and decides the brake pressure by estimating effort of the brake pedal in accordance with amount of the pressure of the master cylinder, a negative level determiner that determines the magnitude of the negative pressure in accordance with the pressure of the booster, a compensation amount determiner that determines the amount of brake pressure to compensate in accordance with the brake intention determined by the brake intention determiner and the magnitude of the negative pressure determined by the negative pressure level determiner, and a control determiner that outputs a braking force control signal by adding deceleration/acceleration conditions, driving conditions, and environment conditions to the amount of the hydraulic brake pressure to compensate which is determined by the compensation amount determiner.

In another aspect of the present invention, a brake pressure compensation method may include determining a vehicle speed, magnitude of a negative pressure in a booster, and pressure of a master cylinder, determining brake intention from a change in pressure of the master cylinder, and deciding a brake pressure from amount of the pressure of the master cylinder, determining compensation amount of the brake pressure by applying the magnitude of the negative pressure in the booster, and performing brake control by compensating for a hydraulic brake pressure through an Electronic Stability Control (ESC) module.

The brake pressure is determined from the pressure of the master cylinder according to a brake effort, one-to-one conversion is performed on the pressure of the master cylinder on the basis of magnitude of a normal negative pressure, and then the compensation amount of braking force is determined in accordance with the magnitude of the negative pressure.

In further another aspect of the present invention, a brake pressure compensation system may include a vehicle speed detector that detects wheel speeds of wheels, a master cylinder pressure detector that detects a change in pressure according to operation of a brake pedal, a booster pressure detector that detects a negative pressure of a booster which is generated by an intake negative pressure of the engine, an engine status detector that detects information including a displacement of an acceleration pedal, status of an intake system, altitude of area where a vehicle travels, and a driving environment, a speed/deceleration estimator that estimates speed and deceleration/acceleration speed by analyzing the wheel speeds of the wheels into a rate of change in speed per unit time, a brake intention determiner that determines brake intention from a change in pressure of the master cylinder and decides a brake pressure by estimating effort of the brake pedal in accordance with the amount of pressure of the master cylinder, a negative level determiner that determines magnitude of the negative pressure in accordance with the pressure of the booster, a compensation amount determiner that determines the amount of brake pressure to compensate in accordance with the brake intention determined by the brake intention determiner and the magnitude of the negative pressure determined by the negative pressure level determiner, and a control determiner that outputs a braking force control signal by including deceleration/acceleration conditions, driving conditions, and environment conditions into amount of hydraulic pressure to compensate which is determined by the compensation amount determiner.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically illustrating a hydraulic brake pressure compensation system according to an exemplary embodiment of the present invention.

FIG. 2 is a flowchart schematically illustrating a process of compensating for a hydraulic brake pressure according to an exemplary embodiment of the present invention.

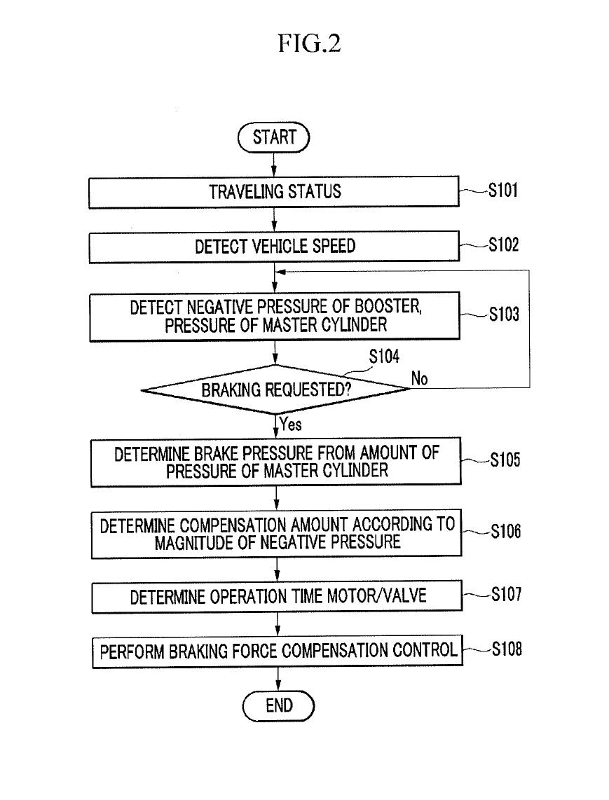

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Components unrelated to the description will be omitted in order to obviously describe the present invention, and like reference numerals will be used to describe like components throughout the present specification.

Further, the components are exemplarily provided for the convenience of description and the present invention is not limited those shown in the drawings.

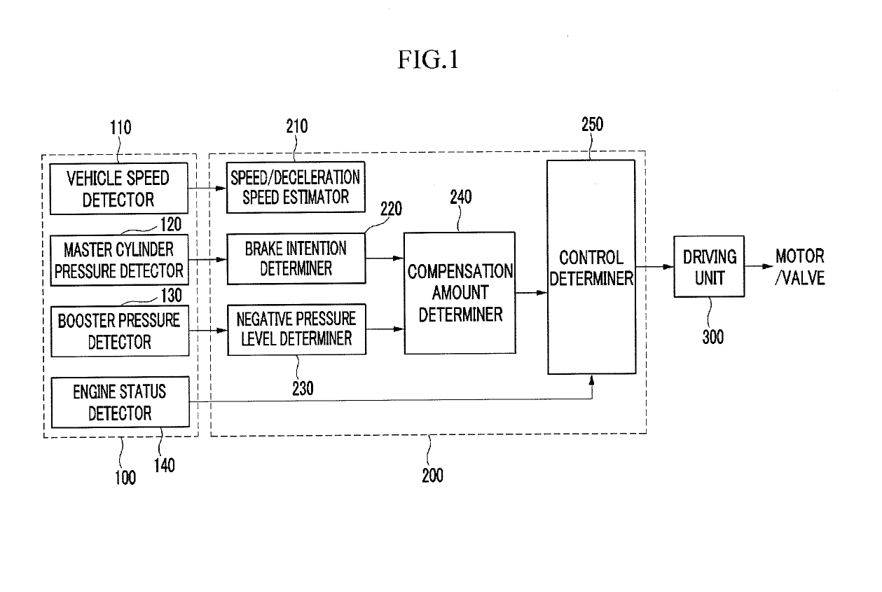

FIG. 1 is a diagram schematically illustrating a hydraulic brake pressure compensation system according to an exemplary embodiment of the present invention.

In an exemplary embodiment of the present invention, the hydraulic brake pressure compensation system may be applied in Electronic Stability Control (ESC)

Referring to FIG. 1, an exemplary embodiment of the present invention includes a sensor unit 100, a control unit 200, and a driving unit 300.

The sensor unit 100 detects the pressure of a master cylinder according to the operation of a brake pedal, a vehicle speed, a booster pressure according to an intake negative pressure of an engine, and the status of the engine, and provides the information of them, as an electric signal, to the control unit 200.

The sensor unit 100 includes a vehicle speed detector 110, a master cylinder pressure detector 120, a booster pressure detector 130, and an engine status detector 140.

The vehicle speed detector 110 includes wheel speed sensor mounted on the wheels, and detects the wheel speed of the wheels and provides the information on the wheel speed to the control unit 200, using electric signals.

The master cylinder pressure detector 120 detects a change in pressure according to the operation of a brake pedal and provides the information on the change to the control unit 200, using electric signals.

The booster pressure detector 130 detects a negative pressure of a booster which is generated by an intake negative pressure of the engine and provides the information on the negative pressure to the control unit 200, using an electric signal.

The engine status detector 140 detects information including a displacement of an acceleration pedal, the status of an intake system, the altitude of the area where a vehicle travels, and the driving environment (climate) while the vehicle travels, and provides the detected information to the control unit 200.

The control unit 200 determines that it is braking intention when detecting a change in pressure of the master cylinder by analyzing the information provided from the sensor unit 100, determines a brake pressure by estimating effort of a brake pedal in accordance with the amount of pressure of the master cylinder, determines the amount of compensation of a brake pressure from the magnitude of the negative pressure of the booster, and then compensating the hydraulic brake pressure with an ESC, thereby providing a stable braking force.

The control unit 200 controls the braking force on the basis of deceleration/acceleration speed of the wheels, the operational conditions of the engine, and the environmental conditions.

The control unit 200 may determine the brake pressure from the pressure of the master cylinder according to the brake effort by applying predetermined map data, perform one-to-one conversion on the pressure of the master cylinder on the basis of the magnitude of a normal negative pressure, and then determine the amount of compensation of the braking force in accordance with the magnitude of the negative pressure.

The control unit 200 includes a speed/deceleration estimator 210, a brake intention determiner 220, a negative pressure level detector 230, a compensation amount determiner 240, and a control determiner 250.

The speed/deceleration estimator 210 estimates speed and deceleration/acceleration speed by analyzing the wheel speeds of the wheels which are provided from the vehicle speed detector 110 into a rate of change in speed per unit time, and provides the speed and deceleration/acceleration speed to the control determiner 250.

The brake intention determiner 220 determines brake intention of a driver from a change in pressure of the master cylinder which is provided from the master cylinder pressure detector, decides a brake pressure by estimating effort of the brake pedal from the amount of pressure of the master cylinder, and provides the brake pressure to the compensation amount determiner 240.

The brake intention determiner 220 sets the effort of the brake pedal according to the pressure of the master cylinder into map data.

The negative level determiner 230 determines the magnitude of the negative pressure from the pressure of the booster which is provided from the booster pressure detector 130 and provides the magnitude of the negative pressure to the compensation amount determiner 240.

The compensation amount determiner 240 determines the amount of hydraulic brake pressure to compensate in accordance with the brake intention of the driver, which is provided from the brake intention determiner 220, and the magnitude of the negative pressure provided from the negative pressure level determiner 230, and provides the amount of hydraulic brake pressure to compensate to the control determiner 250.

The control determiner 250 outputs a braking force control signal to the driving unit 300, by further including deceleration/acceleration conditions of the vehicle and various driving status conditions into the amount of hydraulic pressure to compensate which is provided from the compensation amount determiner 240.

The driving unit 300 compensates for the hydraulic brake pressure by controlling the motor and the valve of the ESC module in response to the control signal supplied from the control determiner 250 in the control unit 200, thereby providing a stable braking force.

The operation of compensating for a hydraulic brake pressure in an exemplary embodiment of the present invention including the function described above is performed as follows.

When a vehicle where the present invention is applied travels (S101), the control unit 200 detects the speed and the deceleration/acceleration speed of the vehicle by collecting the information provided from the vehicle speed detector 110 in the sensor unit 100 (S102).

Further, the control unit 200 detects the magnitude of the negative pressure of the booster by collecting the information provided from the booster pressure detector 130 and detects the pressure of the master cylinder by collecting the information provided from the master cylinder pressure detector 120 (S103).

The control unit 200 determines whether there is a request for braking from the driver, by checking the pressure of the master cylinder and the speed of the vehicle.

It is possible to determine that there is a request (intention) for braking from the driver, when a change in pressure of the master cylinder is detected and a deceleration speed is detected.

When it is determined that there is a request for braking from the driver in S104, the control unit 200 determines a brake pressure by estimating the effort of the brake pedal according to the amount of pressure of the master cylinder by applying predetermined map data (S105).

Further, the control unit 200 determines the amount of compensation of the brake pressure in accordance with the magnitude of the negative pressure by analyzing the magnitude of the negative pressure of the booster (S106).

When the amount of compensation of the brake pressure according to the magnitude of the negative pressure is determined in S106, the control unit 200 provides a stable braking force by determining the operation time of the motor/valve and then performing braking force compensation control for compensating for the hydraulic brake force through the ESC.

As described above, as the brake intention and brake pressure are determined from a change in pressure of the master cylinder, the amount of compensation of the brake pressure is determined in accordance with the magnitude of the negative pressure of the booster, and then the hydraulic brake pressure is compensated by the ESC, stable braking performance can be provided even under a driving situation where a negative pressure of the booster is difficult to generate.

Further, it is possible to simplify the system, and correspondingly reduce the manufacturing cost and improve the fuel efficiency, by removing an effort sensor of the brake pedal.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A brake pressure compensation system comprising:
a sensor unit that detects a pressure of a master cylinder according to operation of a brake pedal, a vehicle speed, a booster pressure according to an intake negative pressure of an engine, and status of the engine;
a control unit that determines brake intention and a brake pressure from the pressure of the master cylinder, determines compensation amount of the brake pressure in accordance with magnitude of negative pressure of the booster, and compensates for a hydraulic brake pressure through an (Electronic Stability Control) ESC; and
a driving unit that controls a motor and a valve of an ESC module to compensate for the hydraulic brake pressure in response to a control signal from the control unit.

2. The system of claim 1, wherein the sensor unit includes:
a vehicle speed detector that includes wheel speed sensor mounted on wheels to detect wheel speed of wheels;
a master cylinder pressure detector that detects a change in pressure according to the operation of the brake pedal;
a booster pressure detector that detects the negative pressure of the booster which is generated by the intake negative pressure of the engine; and
an engine status detector that detects information including a displacement of an acceleration pedal, status of an intake system, altitude of area where a vehicle travels, and a driving environment.

3. The system of claim 1, wherein the control unit determines the brake intention from a change in the pressure of the master cylinder and determines the brake pressure from amount of the pressure of the master cylinder.

4. The system of claim 1, wherein the control unit controls the brake pressure in accordance with deceleration/acceleration speeds of wheels, operational conditions of the engine and environment conditions.

5. The system of claim 1, wherein the control unit determines the brake pressure from the pressure of the master cylinder according to a brake effort, performs one-to-one conversion on the pressure of the master cylinder on the basis of the magnitude of a normal negative pressure, and then determines the compensation amount of the braking force in accordance with the magnitude of the negative pressure.

6. The system of claim 1, wherein the control unit includes:
a speed/deceleration estimator that estimates speed and deceleration/acceleration speed by analyzing wheel speeds of wheels into a rate of change in speed per unit time;
a brake intention determiner that determines the brake intention from a change in pressure of the master cylinder and decides the brake pressure by estimating effort of the brake pedal in accordance with amount of the pressure of the master cylinder;
a negative level determiner that determines the magnitude of the negative pressure in accordance with the pressure of the booster;
a compensation amount determiner that determines the amount of brake pressure to compensate in accordance with the brake intention determined by the brake intention determiner and the magnitude of the negative pressure determined by the negative pressure level determiner; and
a control determiner that outputs a braking force control signal by adding deceleration/acceleration conditions, driving conditions, and environment conditions to the amount of the hydraulic brake pressure to compensate which is determined by the compensation amount determiner.

7. A brake pressure compensation method comprising:
determining a vehicle speed, magnitude of a negative pressure in a booster, and pressure of a master cylinder;
determining brake intention from a change in pressure of the master cylinder, and deciding a brake pressure from amount of the pressure of the master cylinder;
determining compensation amount of the brake pressure by applying the magnitude of the negative pressure in the booster; and
performing brake control by compensating for a hydraulic brake pressure through an Electronic Stability Control (ESC) module.

8. The method of claim 7, wherein the brake pressure is determined from the pressure of the master cylinder according to a brake effort, one-to-one conversion is performed on the pressure of the master cylinder on the basis of magnitude of a normal negative pressure, and then the compensation amount of braking force is determined in accordance with the magnitude of the negative pressure.

9. A brake pressure compensation system comprising:
a vehicle speed detector that detects wheel speeds of wheels;
a master cylinder pressure detector that detects a change in pressure according to operation of a brake pedal;
a booster pressure detector that detects a negative pressure of a booster which is generated by an intake negative pressure of the engine;
an engine status detector that detects information including a displacement of an acceleration pedal, status of an intake system, altitude of area where a vehicle travels, and a driving environment;
a speed/deceleration estimator that estimates speed and deceleration/acceleration speed by analyzing the wheel speeds of the wheels into a rate of change in speed per unit time;
a brake intention determiner that determines brake intention from a change in pressure of the master cylinder and decides a brake pressure by estimating effort of the brake pedal in accordance with the amount of pressure of the master cylinder;
a negative level determiner that determines magnitude of the negative pressure in accordance with the pressure of the booster;
a compensation amount determiner that determines the amount of brake pressure to compensate in accordance with the brake intention determined by the brake intention determiner and the magnitude of the negative pressure determined by the negative pressure level determiner; and
a control determiner that outputs a braking force control signal by including deceleration/acceleration conditions, driving conditions, and environment conditions into amount of hydraulic pressure to compensate which is determined by the compensation amount determiner.
